(19) United States
(12) Patent Application Publication
(10) Pub. No.: US 2010/0056206 A1
(43) Pub. Date: Mar. 4, 2010

(54) ANTENNA MODULE AND PORTABLE ELECTRONIC DEVICE USING THE SAME

(75) Inventors: SHAO-YI TAI, Tu-Cheng (TW); CHO-KANG HSU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/431,857

(22) Filed: Apr. 29, 2009

(30) Foreign Application Priority Data
Sep. 3, 2008 (CN) 200810304356.9

(51) Int. Cl. H04M 1/00; G06F 3/033

(52) U.S. Cl. 455/556.1; 343/702; 343/900

(57) ABSTRACT

A portable electronic device includes a housing, and an antenna module assembled in the housing. The antenna module has multiple signal processing functions, and includes a plurality of signal processing units, a plurality of signal receiving portions, and an antenna. The plurality of signal receiving portions is electrically and respectively connected to the plurality of signal processing units. The antenna including a signal connecting portion to correspondingly engage with each of the plurality of signal receiving portions to realize different signal processing functions.

### BACKGROUND

1. Technical Field

The present disclosure relates to antenna modules and, particularly, to an antenna module having multiple signal processing functions and a portable electronic device using the antenna module.

2. Description of Related Art

With the developments of wireless communication and information processing technologies, portable electronic devices such as mobile phones and personal digital assistants (PDAs) are now in widespread use, and consumers may now enjoy the full convenience of high tech products almost anytime and anywhere.

Typical portable electronic devices generally use an insert type earphone as a frequency modulation (FM) antenna to receive audio signals, or using an exposed antenna as a digital video broadcasting (DVB) antenna to receive mobile television signals, thereby realizing functions of a radio receiver and a digital television. However, it is inconvenient to carry the insert type earphone or the exposed antenna. Additionally, a conventional exposed antenna is relatively large, and occupies a large space within a portable electronic device. Thus, the exposed antenna is not suitable to be applied in small and thin portable electronic devices.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a partial, cross-sectional view of one embodiment of a portable electronic device, the portable electronic device including an antenna and a plurality of signal processing units.

FIG. 2 is a cross-sectional view of the antenna in FIG. 1, taken along line II-II.

FIG. 3 is a block diagram of the antenna and the plurality of signal processing units in FIG. 1.

FIG. 4 is an assembled, plan view of the portable electronic device, showing the antenna partially assembled in the portable electronic device.

FIG. 5 is an assembled, plan view of the portable electronic device, showing the antenna totally assembled in the portable electronic device.

### DETAILED DESCRIPTION

The present antenna module may be used in a portable electronic device, such as a mobile phone, and a personal digital assistant (PDA). Hereinafter, for the purposes of conveniently describing the embodiments of the antenna module, the antenna module used in a mobile phone is described and illustrated.

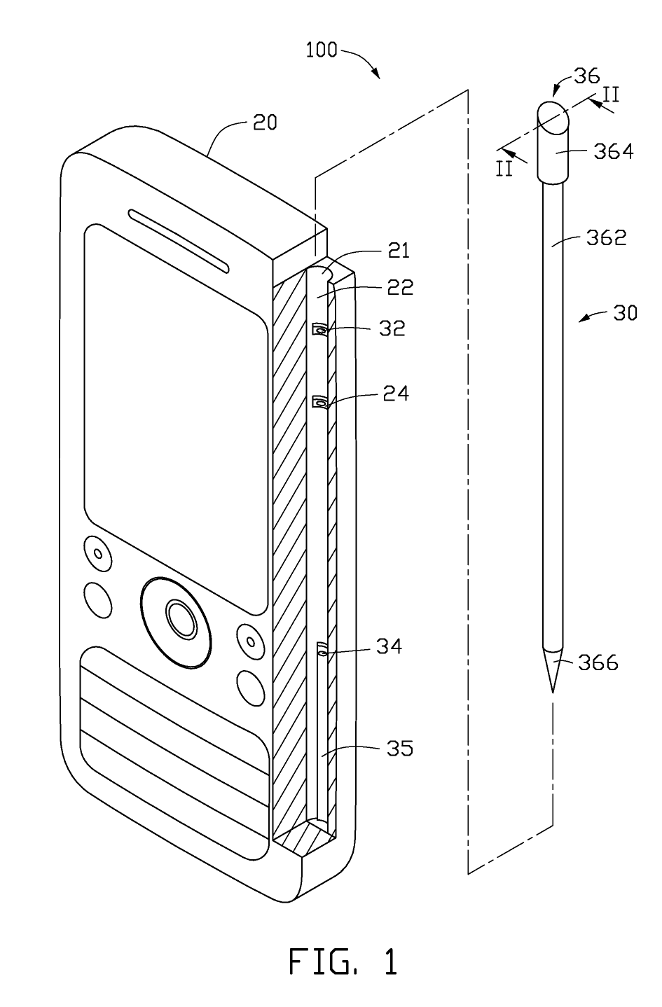

Referring to FIG. 1, an embodiment of a mobile phone 100 includes a housing 20 and an antenna module 30. In the illustrated embodiment, the mobile phone 100 is a touch control mobile phone.

The housing 20 defines a receiving groove 22 extending in a height direction of the housing 20. The receiving groove 22 has an opening 21 defined at a top end of the housing 20. A latching portion 24 is formed on an inner surface of the receiving groove 22. In the illustrated embodiment, the latching portion 24 is an elastic protrusion. The latching portion 24 also may be an elastic ring, or a C-shaped clip.

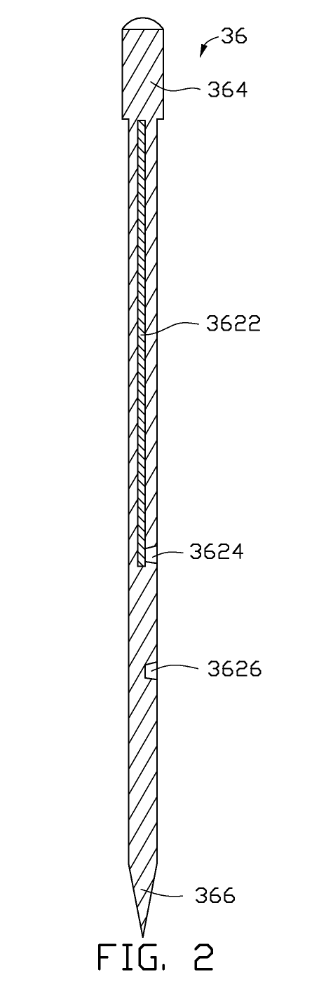

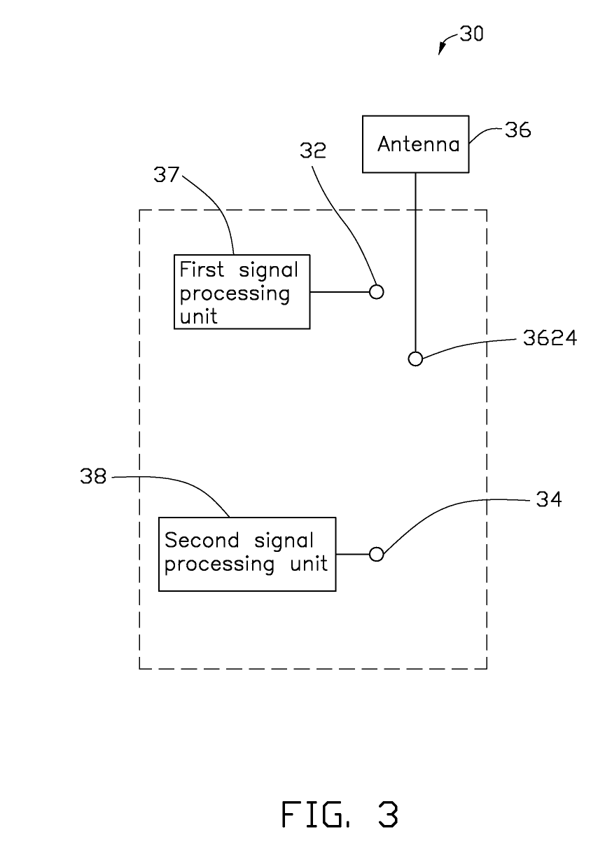

Referring also to FIGS. 2 and 3, the antenna module 30 includes an antenna 36, a first signal receiving portion 32, a second signal receiving portion 34, a first signal processing unit 37 and a second signal processing unit 38. The first signal receiving portion 32 is formed on the inner surface of the receiving groove 22 between the opening 21 and the latching portion 24. The second signal receiving portion 34 is formed on the inner surface of the receiving groove 22 adjacent to a bottom end of the receiving groove 22. The first signal processing unit 37 is positioned in the housing 20 adjacent to the first signal receiving portion 32. The second signal processing unit 38 is positioned in the housing 20 adjacent to the second signal receiving portion 34. The antenna module 30 further includes a conducting wire (not shown) to electrically connect the first signal receiving portion 32 and the first signal processing unit 37, and a conducting strip 35 to electrically connect the second signal receiving portion 34 and the second signal processing unit 38. In the illustrated embodiment, the first and second signal receiving portions 32, 34 are both metallic elastic protrusions. Alternatively, the first and second signal receiving portions 32, 34 may be metallic elastic pieces, or metallic elastic rings.

In the illustrated embodiment, the antenna 36 is shaped as a touch control pen (e.g. stylus), and includes a main body 362, a head portion 364 formed on a first end of the main body 362, and a writing portion 366 formed on a second end of the main body 362 opposite to the first end. The antenna 36 may be made of plastic materials.

The main body 362 is a substantially cylindrical rod to be inserted in the receiving groove 22 of the housing 20. A metallic core 3622 is embedded in the main body 362 to radiate and receive electromagnetic waves. The main body 362 defines a signal connecting portion 3624 communicating with the metallic core 3622, and a latching groove 3626 in a side surface to receive the latching portion 24. In the illustrated embodiment, the signal connecting portion 3624 is an engaging groove to enable the first or the second signal receiving portions 32, 34 to insert in and contact the metallic core 3622. In an alternative embodiment, the signal connecting portion 3624 may be a metallic elastic protrusion extending from the metallic core 3622. Accordingly, the first and second signal receiving portions 32, 34 may be metallic grooves to receive the signal connecting portion 3624.

The head portion 364 is a substantially cylinder. A diameter of the head portion 364 is larger than that of the receiving groove 22, such that the head portion 364 is latched at an outer side of the opening 21 when the main body 362 is inserted in the receiving groove 22. A top surface of the head portion 364 is a slanted surface so as to smoothly adjoin to an outer surface of the mobile phone 100.

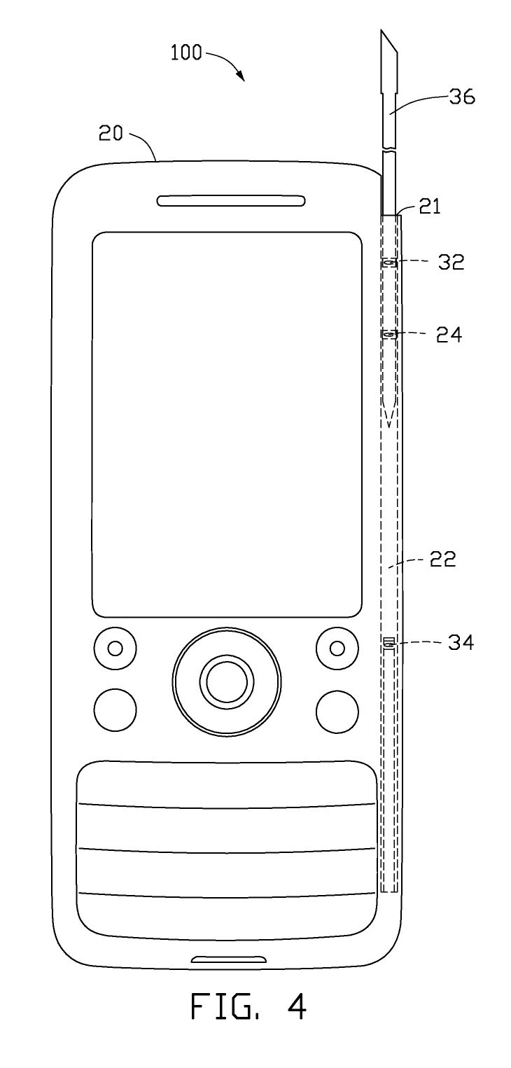

Referring also to FIG. 4, the main body 362 of the antenna 36 is partially inserted in the receiving groove 22 from the opening 21. The first signal receiving portion 32 is engaged in the signal connecting portion 3624, and contacts the metallic core 3622. The latching portion 24 is latched in the latching groove 3626, thus latching the antenna 36 at the present position. The electromagnetic waves are transmitted from the metallic core 3622 to the first signal receiving portion 32, and then transmitted to the first signal processing unit 37 to be converted into a first electric signal. In this embodiment, the first electric signal is a frequency modulation (FM) signal, thereby enabling the mobile phone 100 to realize a function of a radio receiver.

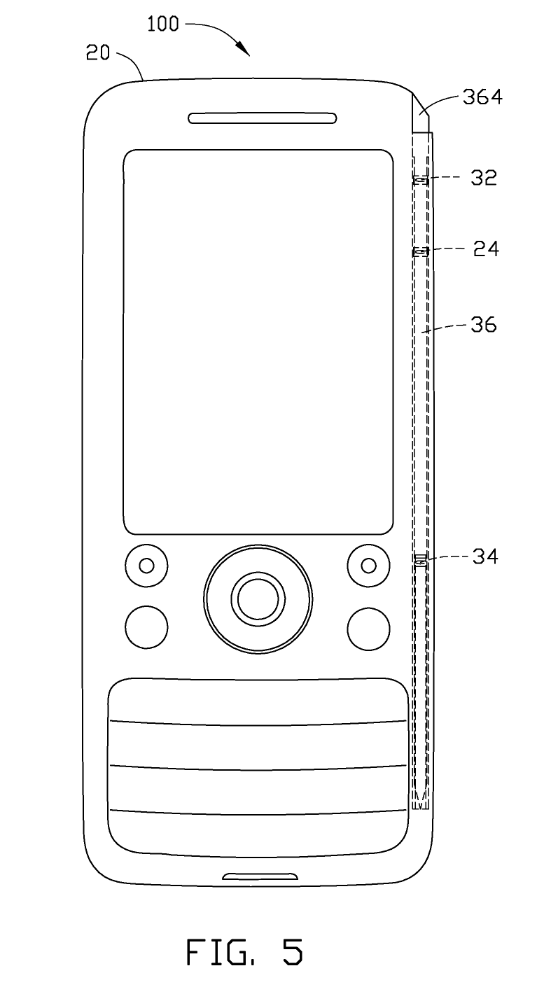

Referring also to FIG. 5, the main body 362 of the antenna 36 is completely inserted in the receiving groove 22 by an external force. The second signal receiving portion 34 is engaged in the signal connecting portion 3624, and contacts the metallic core 3622. The electromagnetic waves are transmitted from the metallic core 3622 to the second signal receiving portion 34, and then transmitted to the second signal processing unit 38 to be converted into a second electric signal. In this embodiment, the second electric signal is a digital video broadcasting (DVB) signal, thereby enabling the mobile phone 100 to realize a function of a digital television.

In above mobile phone 100, a consumer may enjoy the functions of the radio receiver or digital television remotely, by using the antenna 36 to engage with the first or the second signal receiving portions 32, 34 respectively. Thus, the insert type earphone or the exposed antenna are not needed. Therefore, it is convenient to use the mobile phone 100, and reduce the occupying space and decrease the manufacturing cost. In addition, the antenna 36 may be used as a touch control pen and easy to carry with the mobile phone 100, thus making the use of the mobile phone 100 more convenient.

It should be understood that, the mobile phone 100 may have a plurality of signal processing units positioned in the mobile phone 100, and a plurality of signal receiving portions positioned on the inner surface of the receiving groove 22. The plurality of signal receiving portions is electrically connected to the plurality of signal processing units by one to one corresponding means. The signal connecting portion 3624 of the antenna 36 is correspondingly engaged with each of the signal receiving portions, thus enabling the mobile phone 100 to realize multiple signal processing functions.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A portable electronic device comprising:
a housing; and
an antenna module having multiple signal processing functions assembled in the housing, the antenna module comprising:
a plurality of signal processing units;
a plurality of signal receiving portions electrically and respectively connected to the plurality of signal processing units; and
an antenna comprising a signal connecting portion to correspondingly engage with each of the plurality of signal receiving portions to realize different signal processing functions.

2. The portable electronic device of claim 1, wherein the housing defines a receiving groove to receive the antenna; the antenna comprises a metallic core embedded therein; the plurality of signal receiving portions are metallic elastic protrusions formed on an inner surface of the receiving groove; the signal connecting portion is an engaging groove defined in the antenna to enable each of the plurality of signal receiving portions to insert in and contact the metallic core of the antenna.

3. The portable electronic device of claim 1, wherein the housing defines a receiving groove to receive the antenna; the antenna comprises a metallic core embedded therein; the plurality of signal receiving portions are metallic grooves defined in an inner surface of the receiving groove; the signal connecting portion is a metallic elastic protrusion extending from the metallic core of the antenna to insert in each of the plurality of signal receiving portions.

4. The portable electronic device of claim 1, wherein the housing defines a receiving groove to receive the antenna, and forms a latching portion on an inner surface of the receiving groove; the antenna defines a latching groove to engage with the latching portion.

5. The portable electronic device of claim 4, wherein the latching portion is selected form the group consisting of an elastic protrusion, an elastic ring, and a C-shaped clip.

6. The portable electronic device of claim 1, wherein the housing defines a receiving groove; the antenna comprises a main body inserted in the receiving groove, and a head portion formed on an end of the main body; a diameter of the head portion is larger than that of the receiving groove, such that the head portion is latched at an outer side of the receiving groove.

7. The portable electronic device of claim 6, wherein a top surface of the head portion is a slanted surface to be smoothly adjoined to an outer surface of the portable electronic device.

8. The portable electronic device of claim 1, wherein the portable electronic device is a touch control mobile phone; the antenna is shaped as a touch control pen.

9. An antenna module having a plurality of work states used in a portable electronic device, the antenna module comprising:
a plurality of signal processing units;
a plurality of signal receiving portions electrically and respectively connected to the plurality of signal processing units; and
an antenna comprising a signal connecting portion, wherein the signal connecting portion engages with one corresponding signal receiving portion in each work state.

10. The antenna module of claim 9, wherein the antenna comprises a metallic core embedded therein; the plurality of signal receiving portions are metallic elastic protrusions; the signal connecting portion is an engaging groove defined in the antenna to enable each of the plurality of signal receiving portions to insert in and contact the metallic core of the antenna.

11. The antenna module of claim 9, wherein the antenna comprises a metallic core embedded therein; the plurality of signal receiving portions are metallic grooves; the signal connecting portion is a metallic elastic protrusion extending from the metallic core of the antenna to insert in each of the plurality of signal receiving portions.

12. A portable electronic device comprising:
a housing defining a receiving groove, and forming a latching portion on an inner surface of the receiving groove; and
an antenna module comprising:
a first signal processing unit and a second signal processing unit positioned in the housing;
a first signal receiving portion and a second signal receiving portion positioned on the inner surface of the receiving groove and spaced by the latching portion, the first and second signal receiving portions being electrically connected to the first and second signal processing units respectively; and
an antenna assembled in the receiving groove of the housing, the antenna defining a latching groove therein to engage with the latching portion, the antenna comprising a signal connecting portion, wherein the signal receiving portion engages with the first signal receiving portion in a first state to realize a first function and the signal receiving portion engages with the second signal receiving portion in a second state to realize a second function.

13. The portable electronic device of claim 12, wherein the antenna comprises a metallic core embedded therein; the first and second signal receiving portions are metallic elastic protrusions formed on the inner surface of the receiving groove; the signal connecting portion is an engaging groove defined in the antenna to enable each of the first and second signal receiving portions to insert in and contact the metallic core of the antenna.

14. The portable electronic device of claim 12, wherein the antenna comprises a metallic core embedded therein; the first and second signal receiving portions are metallic grooves defined in the inner surface of the receiving groove; the signal connecting portion is a metallic elastic protrusion extending from the metallic core of the antenna to insert in each of the first and second signal receiving portions.

15. The portable electronic device of claim 12, wherein the antenna comprises a metallic core embedded therein to radiate and receive electromagnetic waves; the electromagnetic waves are transmitted from the metallic core to the first signal receiving portion, and then transmitted to the first signal processing unit to be converted into a frequency modulation signal.

16. The portable electronic device of claim 12, wherein the antenna comprises a metallic core embedded therein to radiate and receive electromagnetic waves; the electromagnetic waves are transmitted from the metallic core to the second signal receiving portion, and then transmitted to the second signal processing unit to be converted into a digital video broadcasting signal.

17. The portable electronic device of claim 12, wherein the latching portion is selected form the group consisting of an elastic protrusion, an elastic ring, and a C-shaped clip.

18. The portable electronic device of claim 12, wherein the antenna comprises a main body inserted in the receiving groove, and a head portion formed on a top end of the main body; a diameter of the head portion is larger than that of the receiving groove, such that the head portion is latched at an outer side of the receiving groove.

19. The portable electronic device of claim 18, wherein a top surface of the head portion is a slanted surface to be smoothly adjoined to an outer surface of the portable electronic device.

20. The portable electronic device of claim 12, wherein the portable electronic device is a touch control mobile phone; the antenna is shaped as a touch control pen.
